(19) United States
(12) Patent Application Publication
(10) Pub. No.: US 2019/0099248 A1
(43) Pub. Date: Apr. 4, 2019

(54) REMOVABLE DENTURE

(71) Applicant: Kuan-Ku Chi, Pingtung County (TW)

(72) Inventor: Kuan-Ku Chi, Pingtung County (TW)

(21) Appl. No.: 16/149,148

(22) Filed: Oct. 2, 2018

(30) Foreign Application Priority Data
Oct. 4, 2017 (TW) 106134281

(51) Int. Cl. A61C 13/24; A61C 13/07; A61C 13/01

(52) U.S. Cl. CPC A61C 13/245; A61C 13/01; A61C 13/0025

(57) ABSTRACT

A removable denture for an oral cavity of a human is disclosed. The removable denture includes a denture body and a supporting base. The supporting base is attached to mucosa on an edentulous alveolus and on palatine bones in the oral cavity. The denture body is joined to the supporting base. The denture body comprises a denture teeth for chewing. A central region of the supporting base is less flexible than a periphery region of the supporting base so as to maintain a high adhesion of the periphery region to the mucosa when the oral cavity is in chewing. The supporting base comprises an on-way venting device capable of improving the negative pressure effect between the supporting base and the mucosa so as to prevent the supporting base from falling off.

### CROSS-REFERENCE TO PRIOR APPLICATION

The present application claims the benefit of Taiwanese patent application No. 106134281 filed on Oct. 4, 2017, the contents of which are hereby incorporated by reference.

### BACKGROUND OF THE INVENTION

### Field of the Invention

The invention relates to a removable denture.

### Description of the Related Art

The wear of conventional full-mouth removable dentures on an upper jaw or a lower jaw mainly relies on adhesion force which is created by saliva between the artificial full-mouth removable denture and oral mucosa, and friction force which is created between material of the removable denture and oral mucosa. However, when people are chewing, the dentures on the upper jaw tend to fall off, and the dentures on the lower jaw are easily dislocated and moved. In order to generate a negative pressure effect similar to a suction cup, some vendors will provide a removable denture comprising a concave circular space formed corresponding to a middle portion of a palatine bone of the upper jaw. However, since the gas venting structure for decompression is not provided in the removable denture no vacuum-negative pressure is generated on such a removable denture, and the desired effect of suction-cup like negative pressure is thus theoretically impossible to be found. Other vendors provide a removable denture comprising a gas exhausting device in the aforementioned concave circle space. However, the gas exhausting device stimulates oral mucosa to grow up in the concave circle space and finally block the whole concave circle space. In addition, when the mouth is chewing, the movable mucosa often pulls the immovable mucous to cause undulation of the unmovable mucous, which is particularly easy to occur at lingual frenum side of the lower jaw. Since the base of the artificial removable denture cannot undulate with the oral mucosa while using such conventional full-mouth removable denture, a gap is often formed between the edge of the removable denture and the oral mucosa, and the suction effect is thus destroyed by air entered into the gap, which is called “destroy of edge adaptation”. This problem has not been solved for a long time. In order to improve the height of edge, the “functional special impression” is used by dentist. Even if to do so, the area of the full-mouth removable denture base is reduced, and thereby the stability, retention and supporting performance are reduced. Besides, in the case that patient is under severe residual distraction, the height of edge can no longer be increased since his lingual frenum is too close to the top of the alveolar crest. Therefore, the special impression cannot solve the problem.

Another conventional full-mouth removable denture is made of flexible material (commonly known as a flexible bed). This flexible material is mainly used in some edentulous areas as a “partial removable denture”. With softness generated by using thinner materials, the flexible material can be embedded in the inverted area of the natural tooth served as a hook arm and is able to stabilize the denture in some of the edentulous areas. However, if the flexible material is applied to a full-mouth removable denture, the full-mouth movable denture demands a base made by a thicker material with a larger thickness. As a result, the flexibility of the full-mouth movable denture made by the thicker material will be greatly reduced or even disappeared. The adhesion of the denture on the upper jaw or the lower jaw has the same effect as the full-mouth movable denture made of a hard material, which does not theoretically cause a negative pressure effect, and the edge adaptation is easily destroyed.

Taiwanese Patent No. M411916 discloses a full-mouth removable denture including an outer layer structure and an inner layer structure. The outer layer structure and the inner layer structure can be integrated, detachable or assembled. When the full-mouth removable denture is inserted into an oral cavity, an elastic pad of the inner layer structure is embedded to a base of the outer layer structure so that the inner layer structure and the outer layer structure is attached and unable to detach as an integrated structure. Such a full-mouth removable denture is similar with commercialized variable hard-bed dentures or soft-bed dentures comprising a soft elastic material disposed thereon. Even though capable of increasing support effect to prevent oral mucosa from stinging or hurt by the hard base, however the flexibility of such commercialized denture is greatly decreased since the soft inner layer structure and the hard outer layer structure are mutually attached. When the mouth is chewing, oral muscle and oral mucosa move together and a gap may appear between the elastic pad of the inner layer structure and the oral mucosa and thus destroy the edge adaptation. Air may enter into the gap and the adhesion of the denture is thus decreased. The problem of “destroy of edge adaptation” still exists and is not solved. In addition, the dentures may be moved to left or right due to lateral movement of oral cavity when the mouth is chewing, and a non-working side of the denture may lift up while a working side of the denture lows down due to biting force. Such defect is also occurred while using the removable denture disclosed in Taiwanese Patent No. M411916.

Taiwanese patent No. M400837 discloses a pad device for a denture which is suitably mounted into the oral cavity after a full-mouth denture is worn. However, while mounting such a pad, it will affect the occlusal height that was already regulated by a dentist, and the denture must be regulated again. The denture base must be highly fitted with the oral mucosa. The fitting can be accomplished by dental impression. However, according to Taiwanese Patent No. M400837, a pad comprising a cloth or like disposed on residual ridge is disclosed and taught. Since such a material of cloth is easy to have wrinkle to allow air entering into the denture, the edge adaptation is destroyed before chewing and no adhesion of the denture is occurred. In addition, as no embedded element is disposed on the denture base and the pad, the pad is easy to have winkles and difficult to be fitted with the denture base.

Taiwanese patent publication No. 200901942 discloses a full-mouth removable denture comprising a suction cup element disposed on a base of the full-month removable denture. However, the suction cup element may injure the oral cavity, for example, oral mucosa is stimulated to grow up. The oral mucosa grows up to fill a negative pressure space corresponding to the suction cup and thus disable the suction cup for adhesion of the denture. Theoretically, the full-month removable denture is stably positioned in an oral cavity by positioning effect, stabilizing effect and supporting effect. Although the suction cup may increase the positioning effect, most of base is unable to fit with the oral cavity caused by the existence of the suction cup. Since the fit area between the denture base and the oral cavity is decreased, the stabilizing effect and the supporting effect are thus reduced.

### BRIEF SUMMARY OF THE INVENTION

An object of the present invention is to provide a removable denture having excellent performance in adhesion to oral mucosa, maintaining edge adaptation, increasing adhesion effect on the oral mucosa in condition of chewing, and preventing form dropping out of the removable denture.

Another object of the present invention is to provide a removable denture capable of creating a negative pressure and increasing adhesion of the removable denture on the oral mucosa without causing deformation of oral mucosa.

The invention provides a removable denture adapted for wearing on an oral cavity of a human body. The removable denture in accordance with an exemplary embodiment of the present invention includes a denture body and a supporting base. The denture body comprises an alveolus-mounted base and at least one denture tooth fixed to the alveolus-mounted base, wherein the alveolus-mounted base comprises a mucosa-faced surface and an occlusion surface opposite to the mucosa-faced surface. The supporting base comprises a first contact surface and a second contact surface opposite to the first contact surface. A central region and a periphery region surrounding the central region are defined on each of the first contact surface and the second contact surface along an occlusion direction, and flexibility of the periphery region is greater than flexibility of the central region. The central region of the first contact surface is joined to a central region of the mucosa-faced surface, the periphery region of the first contact surface is detachably attached to a periphery region of the mucosa-faced surface, and the second contact surface is adapted to attach to mucosa on an edentulous alveolus and on palatine bones in an oral cavity.

The removable denture is attached to mucosa in an oral cavity through the supporting base. The periphery region of the supporting base has higher flexibility for tightly attaching and fitting to oral mucosa when the removable denture is worn by a user, so as to maintain the removable denture being positioned on the oral mucosa and prevent the removable denture from falling off.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of a removable denture of the present invention;

FIG. 2 is an exploded view of the removable denture of FIG. 1;

FIG. 3 is an exploded view of the removable denture of FIG. 1 viewed in another view angle;

FIG. 3A is an enlarged view of an one-way venting valve of a denture body of the removable denture of FIG. 1;

FIG. 3B is a cross section of the one-way venting valve of FIG. 3A along a line 3B-3B;

FIG. 4 is a top view of a first supporting base of the removable denture of FIG. 1;

FIG. 5 is a perspective view of a first supporting base of the removable denture of FIG. 1;

FIG. 6 is a partially enlarged view of the first supporting base of FIG. 4;

FIG. 7 is a cross section of the first supporting base of FIG. 6 along a line 7-7;

FIG. 8 is a cross section of the assembled removable denture of FIG. 1;

FIG. 9 depicts the assembled removable denture of FIG. 1 used in an oral cavity; and

FIGS. 10A and 10B depict another embodiment of a first supporting base and a second supporting base of a removable denture of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

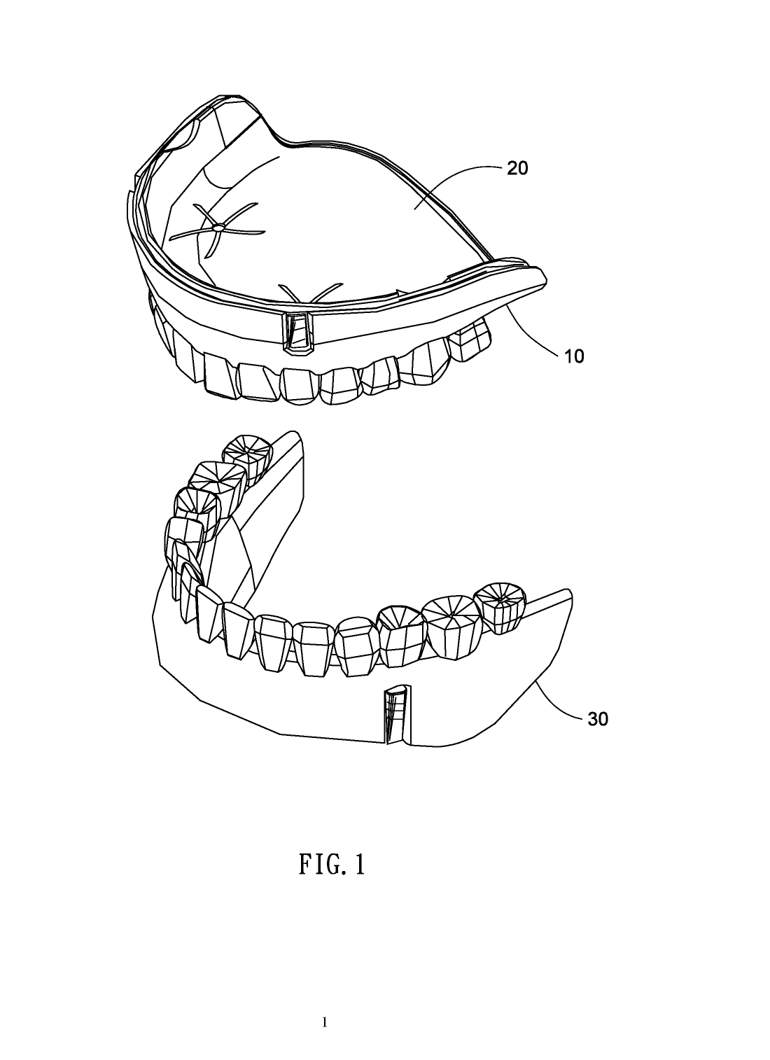

Referring to FIGS. 1, 2 and 3, a removable denture of the invention includes an upper jaw denture body 10, a first supporting base 20, a lower jaw denture body 30 and a second supporting base 40. The removable denture of the invention can be worn on a residual ridge of alveolus in an oral cavity. The residual ridge of alveolus has mucosa on which the removable denture of the invention can be attached to. The removable denture of the invention includes dentures for the upper jaw and for the lower jaw, and is suitable for patients of edentulous disease. The upper jaw denture body 10 and the first supporting base 20 are adapted to be worn on the residual ridge of alveolus on an upper jaw, and the lower jaw denture body 30 and the second supporting base 40 are adapted to be worn on the residual ridge of alveolus on a lower jaw. The upper jaw denture body 10 has a structure similar to the lower jaw denture body 30, and the first supporting base 20 has a structure similar to the second supporting base 40. The size and appearance of the upper jaw denture body 10, the first supporting base 20, the lower jaw denture body 30 and the second supporting base 40 can be modified for different patients, depending on their oral cavity configuration. In this embodiment, the removable denture of the present invention can be applied only to the upper jaw or only to the lower jaw.

The upper jaw denture body 10 includes a mucosa-faced surface 11, a groove 12, a notch 13 and denture teeth 14. In addition, the upper jaw denture body 10 further includes an alveolus-mounted base 15 which is formed by artificially modeling. The mucosa-faced surface 11 is formed on an inner side of the alveolus-mounted base 15. When the removable denture is manufacturing, the first supporting base 20 is formed firstly. A first contact surface 21 of the first supporting base 20 is used to form a working mold through dental impression technique. Afterwards, the upper jaw denture body 10 is formed by the working mold so that an inner surface of the upper jaw denture body 10 may serve as a negative mold mating the first contact surface 21 of the first supporting base 20. A portion of the negative mold corresponding to a first supporting base flexible cover 241 and a notch 242 can be further ground or cut about 0.5 mm to facilitate air flow. Thus, the mucosa-faced surface 11 is formed. The mucosa-faced surface 11 is further processed to have a rough edge 111 having a width of about 2 mm to 10 mm so that an edge of a flexible pad 24 of the first supporting base 20 on the first contact surface 21 side is maintained in a condition that is ready to be detached from the rough edge 111 of the mucosa-faced surface 11 of the upper jaw denture body 10 at any time, when the oral cavity is in a chewing condition, and another edge of the flexible pad 24 on the second contact surface 22 side is attached to the mucosa on the residual ridge of the alveolus and moved along with the mucosa to prevent air from entering into a gap that is formed between the removable denture and the mucosa. Similarly, the mucosa-faced surface 31 is further processed to have a rough edge 311 having a width of about 2 mm to 10 mm so that an edge of a flexible pad 44 of the second supporting base 40 on the first contact surface 41 side is maintained in a condition that is ready to be detached from the rough edge 311 of the mucosa-faced surface 31 of the lower jaw denture body 30 at any time, when the oral cavity is in a chewing condition and another edge of the flexible pad 44 on the second contact surface 42 side is attached to the mucosa on the residual ridge of the alveolus and moved along with the mucosa to prevent air from entering into a gap that is formed between the removable denture and the mucosa. The groove 12 is formed on the mucosa-faced surface 11. The notch 13 is formed on the alveolus-mounted base 15 and extends from the mucosa-faced surface 11 to the other side of the alveolus-mounted base 15. The denture tooth 14 is fixed to the alveolus-mounted base 15. The removable denture is worn in the oral cavity for a patent to chew, speak or other oral exercise. Except the aforementioned structure, the upper jaw denture body 10 has an appearance and a shape similar to a conventional full-mouth removable denture, but the portion corresponding to palatine bone has a horseshoe shape for holding the first supporting base 20.

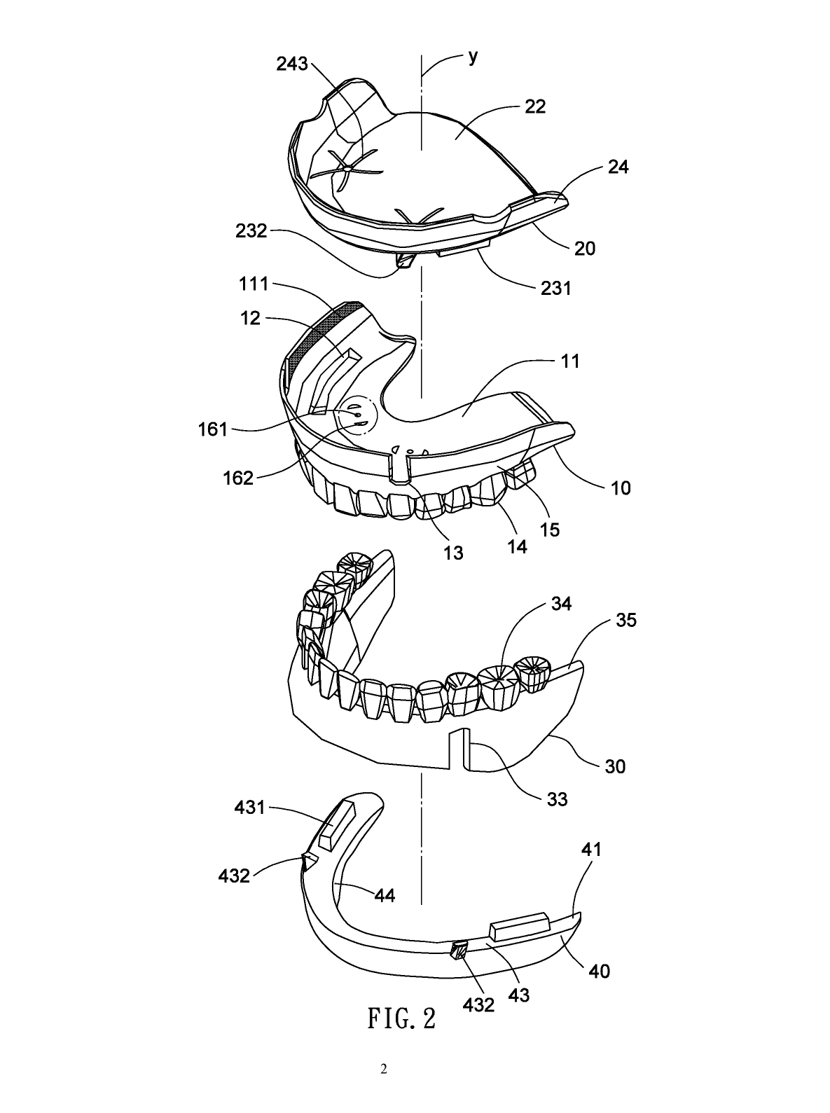

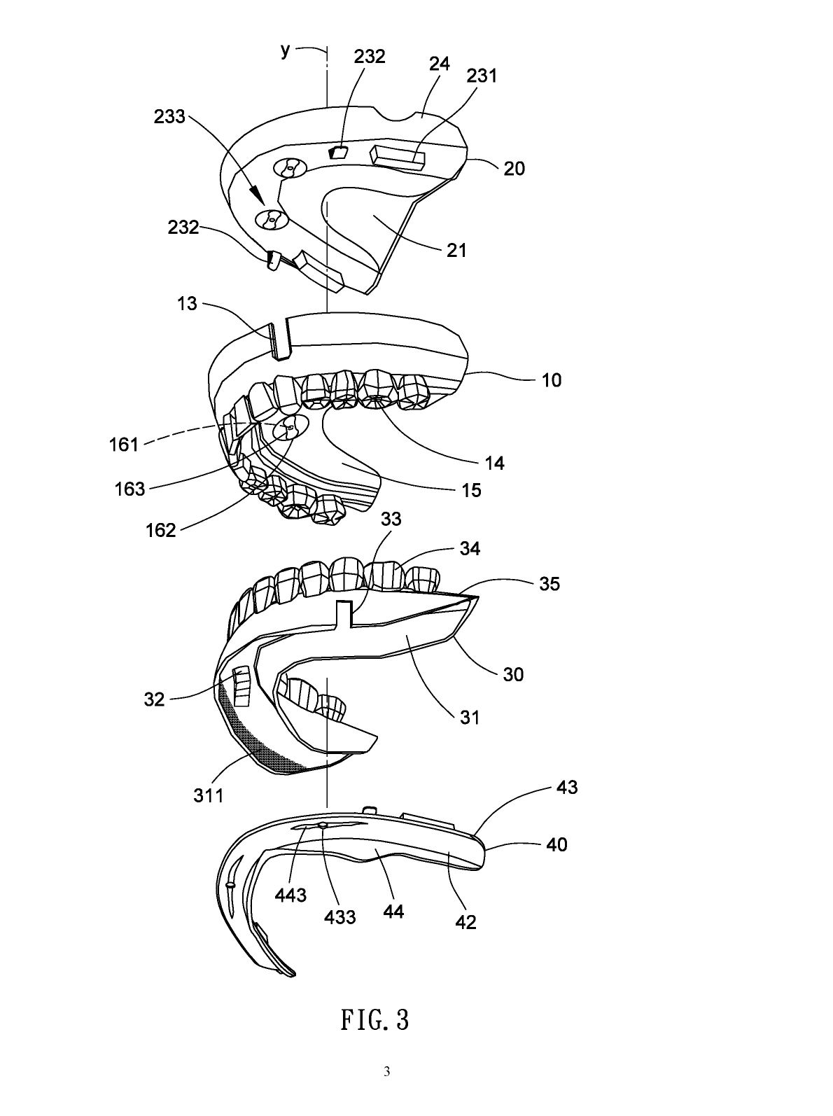

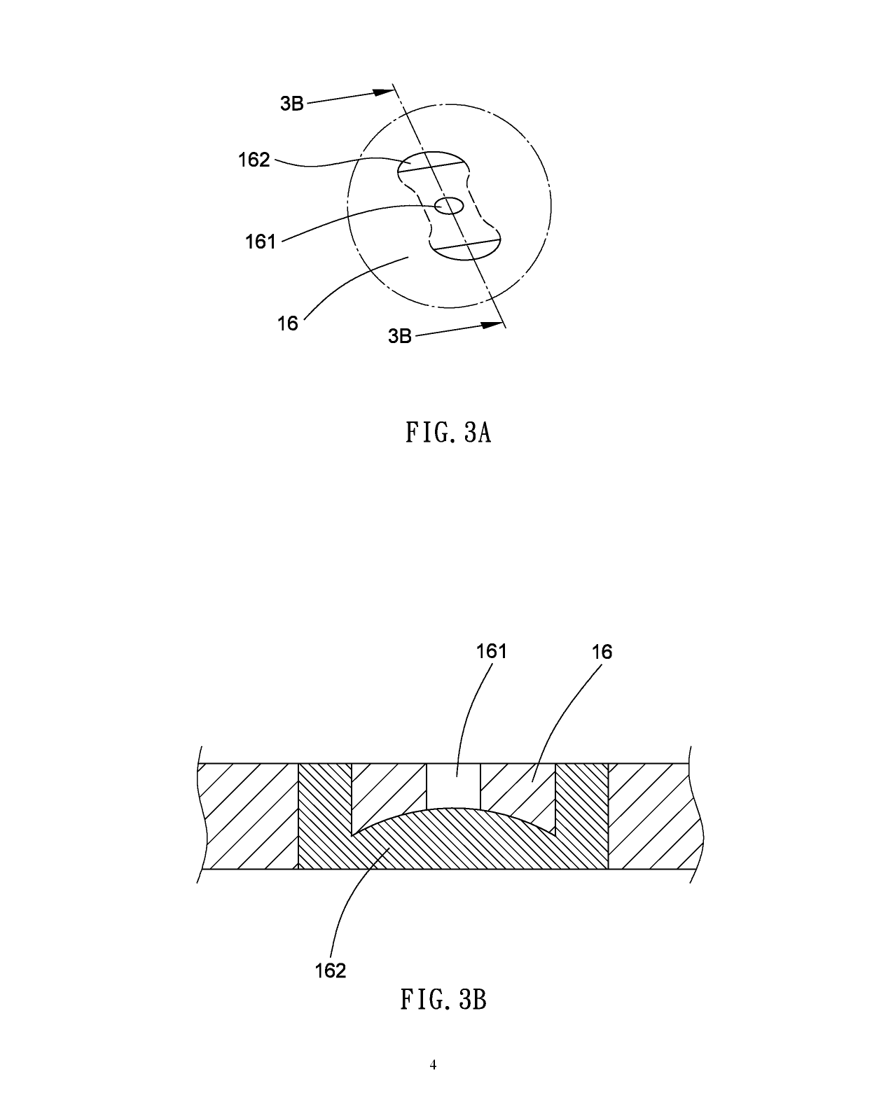

Referring to FIGS. 2, 3, 3A and 3B, the upper jaw denture body 10 includes two one-way venting valves. Each one-way venting valve includes a valve seat 16, a venting hole 161 and a denture body flexible cover 162. The venting hole 161 and the denture body flexible cover 162 are disposed on the valve seat 16. The amount and position of the denture body flexible cover 162 depend on the venting hole 161. The venting hole 161 is at a center of the one-way venting valve 16. The valve seat 16 surrounds the one-way venting hole 161. A portion of the valve seat 16 surrounding the venting hole 161 forms a concave spherical surface, and the venting hole 161 is formed at the center of the concave spherical surface. The valve seat 16 further includes one or more notches 163 adjacent to the denture body flexible cover 162. The venting hole 161 is opened in viewing in a direction perpendicular to the mucosa-faced surface as shown in FIG. 2. As shown in FIG. 3, the denture body flexible cover 162 detachably covers the venting hole 161 and seals the venting hole 161 in a normal condition so that the venting hole 161 and the denture body flexible cover 162 serve as an one-way venting valve. When air pressure on the mucosa-faced surface 11 of the alveolus-mounted base 15 is greater than air pressure on the occlusion surface, a pressure difference between the mucosa-faced surface 11 and the occlusion surface opens the denture body flexible cover 162 so that air flows from the mucosa-faced surface 11 and through the venting hole 161 to push the denture body flexible cover 162 open and then flows to the occlusion surface through the notch 163.

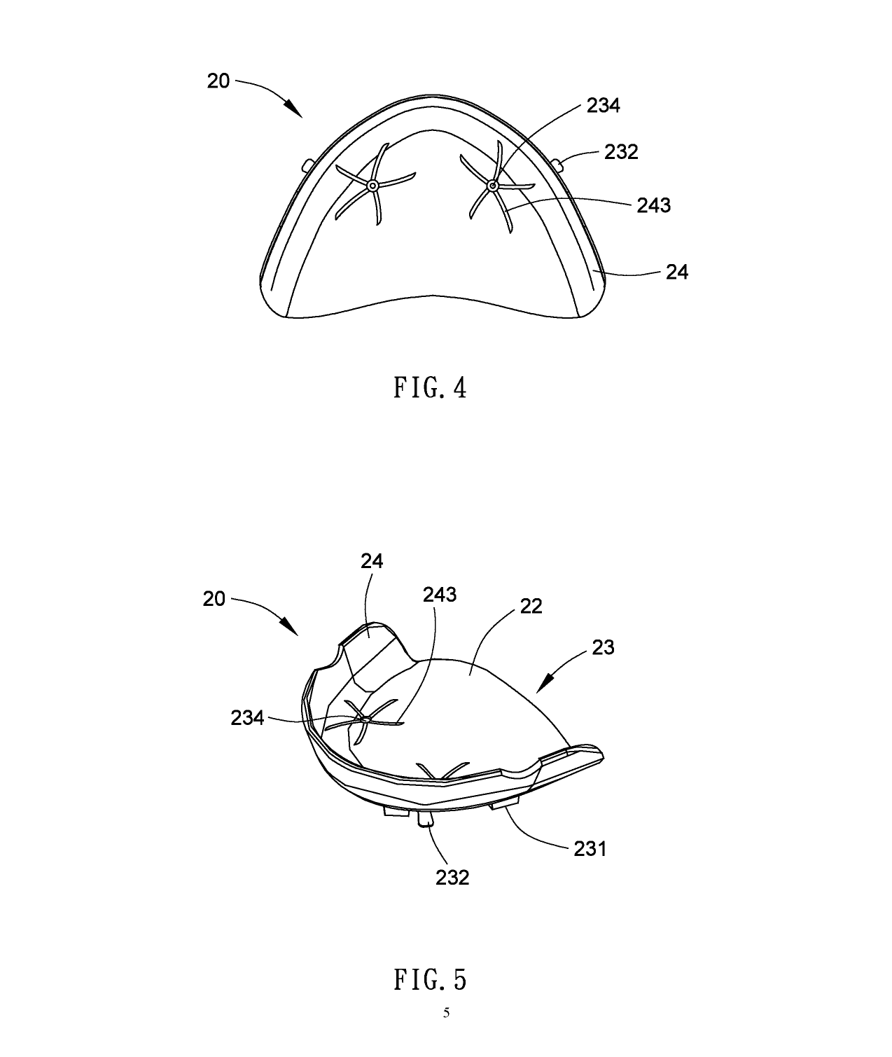

The first supporting base 20 includes a first contact surface 21 and a second contact surface 22 opposite to the first contact surface 21. The first contact surface 21 and the second contact surface 22 are arranged along an occlusion direction y and located on an outer side and an inner side of the first supporting base 20. The second contact surface 22 is adapted to attach to mucosa on residual ridge of alveolus and palatine bones such as mucosa on upper jaw. The first contact surface 21 is detachably attached to the upper jaw denture body 10. As shown in FIGS. 3 and 4, the first supporting base 20 includes a central base 23 and a flexible pad 24 configured to attach to the mucosa on residual ridge of alveolus and palatine bones. A central portion of the flexible pad 24 surrounds the central base 23. In viewing along the occlusion direction y, the flexible pad 24 encloses a periphery of the central base 23 so that the first supporting base 20 includes a central region including the central base 23 and the central portion of the flexible pad 24 and a periphery region including the flexible pad 24 only. That is the periphery region of the first supporting base 20 contains the flexible pad 24 only. The flexible pad 24 is made of a film formed by a chemical material with softness such as a soft resin, a silicon gel and the like. Therefore, flexibility of the periphery region is greater than flexibility of the central region. When the second contact surface 22 is attached to the mucosa in the oral cavity, the periphery region follows the movement of the movable mucosa to maintain the tight adhesion of the removable denture on the mucosa and ensure the gas tightness between the second contact surface 22 and the mucosa when the oral cavity is chewing. In this embodiment, the first supporting base 20 can be made of a single chemical material such as a silicon gel, a plastic or a rubber and the like. However, the chemical material forms greater hardness in the central region than in the periphery region. In another embodiment, the first supporting base 20 is made of chemical material of different hardness such as plastic, which provides similar effect to the previous embodiment. Referring to FIGS. 4 and 5, the flexible pad 24 encloses the central base 23 on the second contact surface 22 so that when the second contact surface 22 is attached to the mucosa, the central base 23 is prevented from contact the mucosa directly, which causes uncomfortable feelings of patient. The flexible pad 24 encloses a bottom of the central base 23 on the second contact surface 22 so that the central base 23 is hidden in the flexible pad 24 and not reveal from the second contact surface 22. In another embodiment, a portion of the central base 23 is allowed to be not enclosed by the flexible pad 24 as long as the gas tightness between the second contact surface 22 and the mucosa is maintained. Referring to FIGS. 2 and 3, the flexible pad 24 encloses at least the periphery of the central base 23 on the first contact surface 21 to form the first contact surface 21 which is the outer surface of the first supporting base 20. In another embodiment, the central base 23 of the first supporting base 20 is permanently joined to the upper jaw denture body 10, but the periphery region must be detachably attached.

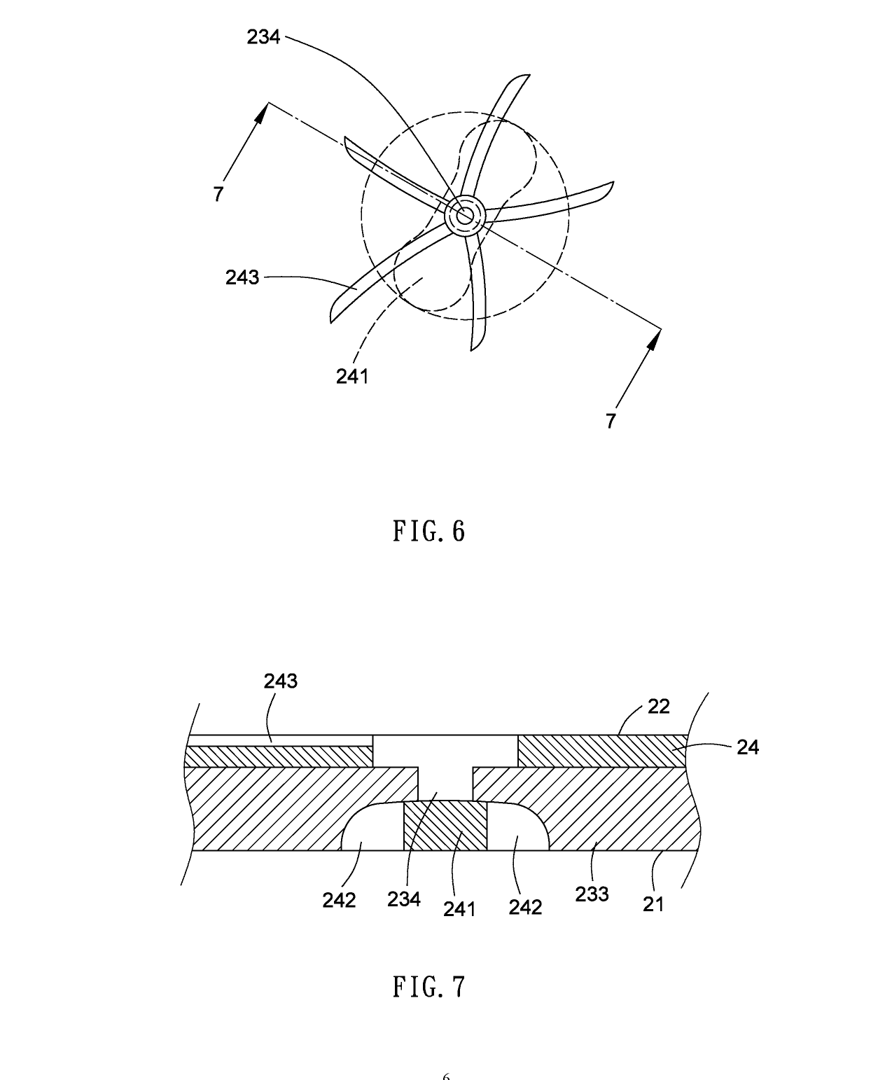

The central base 23 includes one or more connectors 231 and one or more detaching buttons 232. In this embodiment, the central base 23 is made of a non-metal material (such as a silicon gel, resin or rubber having higher hardness). In another embodiment, the central base 23 is made of metal with flexibility often used in dental technique (such as titanium alloy, cobalt chromium alloy and the like) which is able to support the flexible pad 24. Referring to FIGS. 4 to 7, the central base 23 includes two one-way venting valves. Each one-way venting valve includes a venting hole 234 formed at the center of the one-way venting valve and a valve seat 233 surrounding the venting hole 234. The venting hole 234 is not completely covered by the flexible pad 24 as shown in FIG. 7. The flexible pad 24 does not cover the venting hole 234 on the second contact surface 22 side, and a concave spherical surface is formed on the first contact surface 21 of the central base 23. The venting hole 234 is formed at the center of the concave spherical surface. The flexible pad 24 includes one or more first supporting base flexible covers 241 on the first contact surface 21 side. The amount of the first supporting base flexible cover 241 corresponds to the amount of the venting hole 234. The first supporting base flexible cover 241 is configured to detachably cover the venting hole 234 on the first contact surface 21 and maintain the venting hole 234 in a sealed condition. The valve seat 233 includes one or more notches 242 adjacent to the first supporting base flexible cover 241. The notch 242 enables the first supporting base flexible cover 241 to detach from the venting hole 234 when the first supporting base flexible cover 241 is driven by air pressure supporting the venting hole 234, whereby the first supporting base flexible cover 241 and the venting hole 234 serve as an one-way venting valve. When air pressure on the second contact surface 22 is greater than air pressure on the first contact surface 21, a pressure difference between the second contact surface 22 and the first contact surface 21 opens the first supporting base flexible cover 241 so that air flows from the second contact surface 22 and through the venting hole 234 to push the first supporting base flexible cover 241 open and then flows to the first contact surface 21 through the notch 242. Afterwards, the air flows through the venting hole 161 to push the denture body flexible cover 162 open and then flows out of the removable denture through the notch 163. In another embodiment, depending upon requirements, it is possible to form only one venting hole 161 and only one venting hole 234.

Referring to FIGS. 2 and 3, in this embodiment, the central base 23 on the upper jaw is formed to match the contour of the residual ridge, the tongue and the palatine bone. When the central base is applied to the lower jaw, the central base is formed to match the contour of residual ridge, the cheek and the tongue. The connectors 231 are arranged and fixed to the central base 23 to correspond to the top of the alveolus. The connector 231 has a shape of frustum which can be cone frustum or a pyramid frustum or combination of them. The taper of the frustum is designed to range from 1° to 6° according to the dental bi-layer crown technique. The larger is the oral cavity, the frustum is designed to have a larger area, and the taper is also larger. The connector 231 is not enclosed by the flexible pad 24 and revealed from the first contact surface 21. When the first contact surface 21 is joined to the upper jaw denture body 10, the connector 231 engages with the groove 12 of the upper jaw denture body 10, whereby the upper jaw denture body 10 is positioned to the first supporting base 20. The detaching button 232 has a maximal thickness of 5 mm and fixed to the central base 23. The position of the detaching button 232 corresponds to a patient's oral cavity. For example, the detaching button 232 may corresponds to premolar. The detaching button 232 extends toward patient's cheek, and the detaching button 232 protrudes from the upper jaw denture body 10 through the notch 13 when the upper jaw denture body 10 is joined to the first supporting base 20. When the patient intends to remove the denture, he/she pushes the detaching button 232 and pulls the upper jaw denture body 10 to separate the upper jaw denture body 10 from the first supporting base 20.

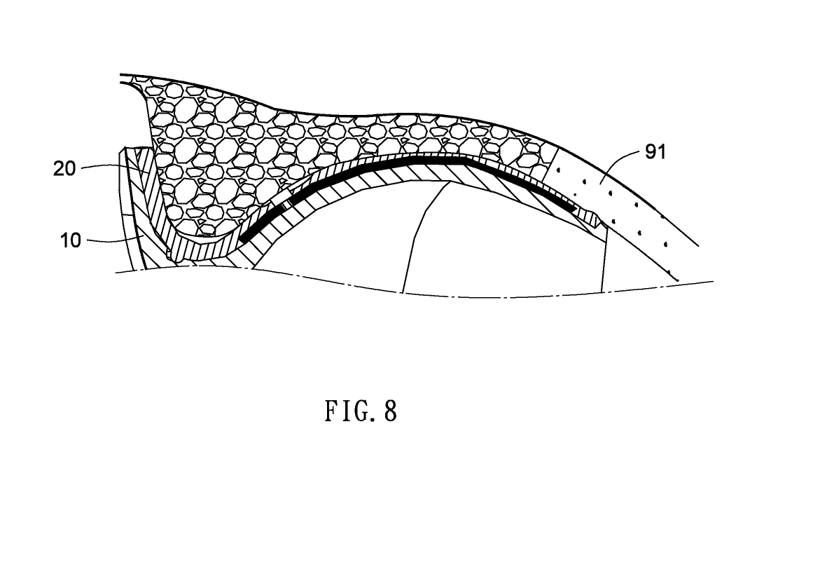

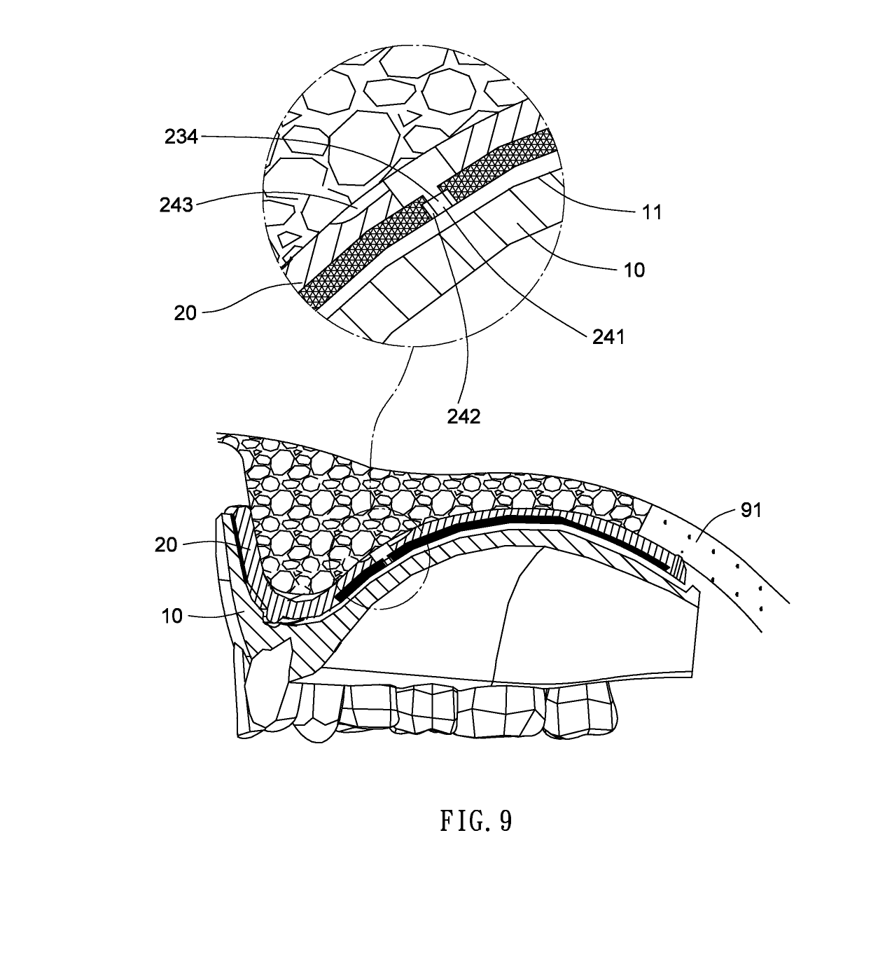

Referring to FIGS. 2 and 5, the flexible pad 24 has a thickness of about 0.1 mm-2 mm and has a periphery similar to a conventional full-mouth removable denture. As shown in FIGS. 8 and 9, The central region of the flexible pad 24 is attached to the central base 23 and the rear edge of the flexible pad 24 extends to ⅓ an upper jaw soft tissue 91 behind the upper jaw. The flexible pad 24 includes several venting passages 243 shaped as a thin slot depressed from the second contact surface 22. The venting passages 243 are formed on the second contact surface 22 and extend to the venting hole 234. The venting passages 243 communicate with the venting hole 234. The venting passages 243 are slots extending in arbitrary directions or extending as branches. The venting passages 243 are formed by coating a thin layer of wax or other flushable material on an oral cavity mold of a patient which is obtained by dental impression technique (a preset space is reserved between two interfaces to prevent the interfaces contact directly). The coating has thickness and width of 0.1 mm-0.5 mm. A working mold is made through the dental impression technique. Several slots of 0.1 mm-0.5 mm are formed on the second contact surface 22 of the flexible pad 24 when the first supporting base 20 is formed by the working mold. The slots are the venting passages 243.

Referring FIGS. 1 to 3, when a patient wears the removable denture of the present invention, he/she puts the first supporting base 20 into his/her oral cavity. The second contact surface 22 of the first supporting base 20 is attached to mucosa of the patient when the first contact surface 21 is pressed by the patient. The first supporting base 20 is stably attached to the mucosa by the adhesion force of saliva and the periphery region of the first supporting base 20. When the first contact surface 21 is slightly pressed by the patient, air between the second contact surface 22 and the mucosa and in the venting passages 243 are pressed, and thus the air pressure therein rises. When the air pressure on the second contact surface 22 is higher than the air pressure on the first contact surface 21, air flows through the venting passages 243 and the venting hole 243 to push the supporting base flexible cover 241 open, and then the air flows to the first contact surface 12 through the notch 242. When the patient release the first supporting base 20, since the air between the second contact surface 22 and the mucosa is purged, the second contact surface 22 has been tightly attached to the mucosa or in a negative pressure status (relative to vacuum) and the venting passages 243 is in a negative pressure status (relative to vacuum), the first supporting base 20 is maintained to be attached to the mucosa of his/her oral cavity. When the first supporting base 20 is positioned in the oral cavity, the upper jaw denture body 10 can be joined to the first supporting base 20. When the upper jaw denture body 10 is joined to the first supporting base 20, the mucosa-faced surface 11 contacts the first contact surface 21. The patient may further slightly press the upper jaw denture body 10 so as to press the first supporting base 20 again.

After the removable denture has been worn into the patient's oral cavity, the upper jaw denture body 10 and the first supporting base 20 are pressed when the patient is chewing. If air or saliva enters between the second contact surface 22 and the mucosa, the air or saliva can be purged to a space between the upper jaw denture body 10 and the first supporting base 20 through the venting passages 234, and then purged out of the upper jaw denture body 10 through the venting hole 161, whereby the negative pressure status is maintained between the second contact surface 22 and the mucosa, and the first supporting base 20 is stably attached to the mucosa without sliding or even falling off. Since the mucosa-faced surface 11 has a rough edge 111, the periphery of the mucosa-faced surface 11 is ready to be detached from the periphery of the flexible pad 24 at any time, but the periphery of the flexible pad 24 is maintained to be tightly attached to the mucosa. When the patient is chewing, the periphery of the flexible pad 24 moves along with the movable mucosa but air is prevented from entering the first supporting base 20 and the mucosa, which contributes the adhesion of the first supporting base 20 to the mucosa.

Referring to FIGS. 1 to 3, the structure of the lower jaw denture body 30 is similar to the structure of the upper jaw denture body 10. The lower jaw denture body 30 includes a mucosa-faced surface 31, a groove 32, a notch 33 and denture teeth 34. The lower jaw denture body 30 further includes a alveolus-mounted base. The mucosa-faced surface 31 has a rough edge 311. The second supporting base 40 has a structure similar to the structure of the first supporting base 20. The second supporting base 40 includes a first contact surface 41, a second contact surface 42, a central base 43 and a flexible pad 44. The central base 43 includes connectors 431 and a detaching button 432. The mucosa-faced surface 31 of the lower jaw denture body 30 is formed through the dental impression technique as the mucosa-faced surface 11 of the upper jaw denture body 10. A working mold is made by the first contact surface 41 of the second supporting base 40 through dental impression technique. The lower jaw denture body 30 is formed by the working mold. The inner surface of the lower jaw denture body 30 serves as a cavity mold for the first contact surface 41 of the second supporting base 40. The inner surface of the lower jaw denture body 30 is the mucosa-faced surface 31 of the lower jaw denture body 30. The flexible pad 44 includes several venting passages 443 which are exemplarily narrow slots. The flexible pad 44 encloses the periphery of the central base 43. The difference between the upper jaw denture body 10 and the lower jaw denture body 30 is that the upper jaw denture body 10 and the first supporting base 20 are worn on the upper jaw, whereas the lower jaw denture body 30 and the second supporting base 40 are worn on the lower jaw. The venting passages 433 of the flexible pad 44 has the same effects and functions as the venting passages 234 of the flexible pad 24, and the description of the venting passages 433 is thus neglected.

Since the one-way venting valve structure generates the highly negative pressure effects, when the patient intends to remove the denture, the upper jaw denture body 10 and the lower jaw denture body 30 are easily removed from the first supporting base 20 and the second supporting base 40 through the detaching buttons 232 and 432 respectively. However, the first supporting base 20 and the second supporting base 40 are still tightly attached to mucosa on the upper jaw and the lower jaw due to the negative pressure effects. To avoid injuring the patient, the venting passages 243 and 443 are designed to have one or two venting passages 243 and 443 extending from tongue side to cheek side, but the central base 23 and 43 extends not yet to cheek side. The patient merely needs to rub the portion of the flexible pads 24 and 44 where the venting passages 243 and 443 extending from tongue side to cheek side is formed so that air is allowed to enter the venting passages 243 and 443 and thus reduce the negative pressure effects, whereby the first supporting base 20 and the second supporting base 40 can be easily removed.

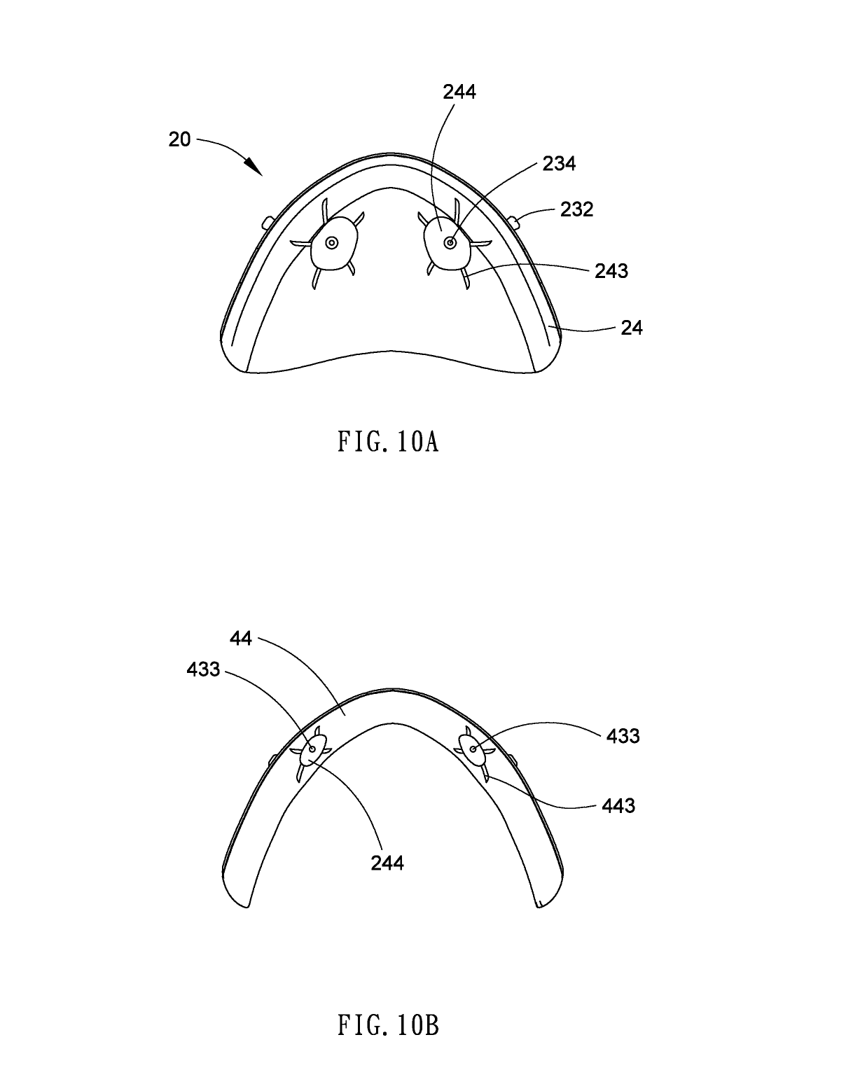

Referring to FIGS. 10A and 10B, for some patients who need the negative pressure effects to be enhanced, for example the patient's alveolus bone is seriously shrunk, an active concave surface is formed around the venting hole 234 on the second surface 22 of the first supporting base 20 or around the venting hole 433 on the second surface 42 of the second supporting base 40. The venting passages 243 and 443 extend from the active concave surface in all directions to enhance the negative pressure effect. However, it is noticed that the venting passages 243 and 443 are not allowed to approach the boundary of the second contact surface 22 and 42. When the patient is chewing, the upper jaw denture body 10 presses the first supporting base 20 through a biting force or other forces to enable the first supporting 20 to attach to the mucosa more tightly. At this time, air between the flexible pads 24, 44 and the mucosa is squeezed out through the venting holes 234 and 433. When the biting force disappears, air is not sucked to reverse back due to the one-way venting valve structure. As the flexible pads 24 and 44 and the mucosa are flexible, the active concave surface 244 restores its original space. At this time, the concave surface 244 serves as a negative pressure chamber where a vacuum-negative pressure status (relative vacuum) is formed. The thickness of the active concave surface 244 must be designed in a range of 0.1 mm to 0.5 mm. Accordingly, in the second embodiment, it is required to tell the patient firstly that the mucosa under the surface of the notch may cause a hyperplasia and it is preferred to have an approval from the patient prior to manufacture of a removable denture. The existence of the active concave surface 244 will stimulate the mucosa to grow up therein. However, when the thickness of the active concave surface 244 is designed in a narrow range, the active concave surface 244 is completely attached to the mucosa when the biting force exerts. The growing of mucosa can be controlled in a very small area.

The removable denture of the present invention provides a greater flexibility of the periphery region of the supporting base, which enables the supporting base to move along with the mucosa and attach the mucosa when the patient is chewing. This contributes to the high gas tightness between the supporting base and the mucosa and improves the positioning stability of the removable denture in the oral cavity.

Since the supporting base includes the central base and the flexible pad, and the central region has a lower flexibility (more rigid) than the periphery region, the central base or the more rigid central region maintains and supports the whole structure of the supporting base so as to prevent the flexible pad or the more flexible periphery region from folding or wrinkling which may reduce the gas tightness between the supporting base and the mucosa. This contributes to the high gas tightness between the supporting base and the mucosa and improves the positioning stability of the removable denture in the oral cavity.

The venting passages are distributed in the second contact surface of the supporting base to provide the negative pressure effect for all portions of the second contact surface without causing deformation of the mucosa. Since the venting passage is narrow and shallow, the venting passages are pressed to tightly attach to the mucosa, which prevents the growing of the mucosa due to the negative pressure effect. In a normal condition, the growing of the mucosa is controlled in a very small area and is almost non-visible.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A removable denture, comprising:
a denture body comprising an alveolus-mounted base and at least one denture tooth fixed to the alveolus-mounted base, wherein the alveolus-mounted base comprises a mucosa-faced surface and an occlusion surface opposite to the mucosa-faced surface; and
a supporting base comprising a first contact surface and a second contact surface opposite to the first contact surface; wherein the second contact surface is adapted to attach to mucosa on an edentulous alveolus and on palatine bones in an oral cavity, and when a central region and a periphery region surrounding the central region are defined on each of the first contact surface and the second contact surface along an occlusion direction, the central region of the first contact surface is joined to a central region of the mucosa-faced surface of the denture body, the periphery region of the first contact surface is detachably attached to a periphery region of the mucosa-faced surface of the denture body, and flexibility of the periphery region is greater than flexibility of the central region.

2. The removable denture as claimed in claim 1, wherein the denture body comprises at least one venting hole formed on the alveolus-mounted base and at least one denture body flexible cover which is disposed correspondingly to the at least one venting hole on the alveolus-mounted base; in which the at least one venting hole is opened when the at least one venting hole is viewed in a direction perpendicular to the mucosa-faced surface; the at least one denture body flexible cover is configured to detachably cover the at least one venting hole and seal the at least one venting hole in a normal condition when the at least one denture body flexible cover is viewed in a direction perpendicular to the occlusion surface; and
when air pressure on the mucosa-faced surface is greater than air pressure on the occlusion surface, a pressure difference between the mucosa-faced surface and the occlusion surface leads to open the at least one denture body flexible cover to allow air flow from the mucosa-faced surface to the occlusion surface.

3. The removable denture as claimed in claim 1, wherein the supporting base comprises: a flexible pad which is disposed on the periphery region of the second contact surface and configured to attach to the mucosa on the edentulous alveolus and on the palatine bones in the oral cavity, at least one venting hole, at least one supporting base flexible cover, and the at least one supporting base flexible cover corresponding to the at least one venting hole; wherein
the at least one venting hole is opened without being covered by the supporting base flexible cover when the venting hole is viewed in a direction perpendicular to the second contact surface;
the at least one supporting base flexible cover is configured to detachably cover the venting hole and seal the venting hole in a normal condition when the supporting base flexible cover is viewed in a direction perpendicular to the first contact surface; and
when air pressure on the second contact surface is greater than air pressure on the first contact surface, a pressure difference between the second contact surface and the first contact surface leads to open the at least one supporting base flexible cover to allow air flow from the second contact surface to the first contact surface.

4. The removable denture as claimed in claim 3, wherein the flexible pad extends above the at least one venting hole to serve as a flexible cover, in which a spherical concave surface surrounds the at least one venting hole, wherein
the spherical concave surface comprises at least one notch formed on a boundary thereof and adjacent to the at least one supporting base flexible cover, and
when the air pressure on the second contact surface is greater than the air pressure on the first contact surface, the pressure difference between the second contact surface and the first contact surface leads to open the at least one supporting base flexible cover to allow air flow from the second contact surface to the first contact surface.

5. The removable denture as claimed in claim 3, wherein the flexible pad comprises at least one venting passage which is formed on the second contact surface, and communicates with the at least one venting hole.

6. The removable denture as claimed in claim 3, wherein the flexible pad comprises at least one venting passage and at least one concave surface formed on the second contact surface, wherein
the at least one concave surface communicates with the at least one venting hole of the supporting base,
the at least one venting passage communicates with the at least one concave surface, and
the at least one venting passage extends from a boundary of the at least one concave surface to the extent without intersecting with an outer contour of the flexible pad.

7. The removable denture as claimed in claim 1, wherein the denture body comprises a rough edge which is configured to enable the periphery region of the first contact surface to be detachable from the periphery region of the mucosa-faced surface when the periphery region of the first contact surface is attached to the he periphery region of the mucosa-faced surface.
